(19) United States
(12) Patent Application Publication
(10) Pub. No.: US 2023/0327602 A1
(43) Pub. Date: Oct. 12, 2023

(54) IMPROVED C-CHANNEL FOR SOLAR TRACKER

(71) Applicant: Nextracker LLC, Fremont, CA (US)

(72) Inventors: James Butcher, Forest Lodge (AU); David Zhang, Roseville (AU); Daniel Y Abraham, Oakland, CA (US)

(21) Appl. No.: 17/714,753

(22) Filed: Apr. 6, 2022

(51) Int. Cl. H02S 20/32; H02S 30/10; F16M 11/18

(52) U.S. Cl. CPC H02S 20/32; H02S 30/10; F16M 11/18

(57) ABSTRACT

A solar tracking system includes a beam including a pair of legs disposed in spaced relation to one another and extending between respective first and second end portions, a web extending between the first end portion of each of the pair of legs, the web including a V-shaped notch defined therein, and a pair of return flanges defining a respective first end portion disposed on respective second end portions of the pair of legs, the pair of return flanges extending from each respective leg of the pair of legs and terminating at a second end portion defining a gap between the second end portions of the pair of return flanges, and a bearing housing assembly selectively couplable to a portion of the beam.

### BACKGROUND

### Technical Field

The present disclosure relates to solar power generation systems, and more particularly, to support structures for solar arrays within a solar tracking system.

### Background of Related Art

Solar tracking system utilize a tremendous amount of material in their construction, not least of which is the support structures on which the solar modules are mounted. As can be appreciated, the cost associated with the construction of the support structures can be extraordinarily high given the amount of piles, piers, frames, etc. required to support hundreds if not thousands of solar modules in a typical solar tracking system installation. In view of these costs, designers often seek to minimize the amount of material required to adequately support solar modules. However, reducing the amount of material used, by reducing the thickness of the material or changing the shape of the beam, often results in reduced strength in one or more directions, reducing the overall effectiveness of the beam resulting in failure or a need to increase the number of beams used to provide the desired strength. In view of these shortcomings, beam designs that utilize less material but provide the necessary strength and stability are desired.

### SUMMARY

In accordance with an aspect of the present disclosure, a solar tracking system includes a beam including a pair of legs disposed in spaced relation to one another and extending between respective first and second end portions, a web extending between the first end portion of each of the pair of legs, the web including a V-shaped notch defined therein, and a pair of return flanges defining a respective first end portion disposed on respective second end portions of the pair of legs, the pair of return flanges extending from each respective leg of the pair of legs and terminating at a second end portion defining a gap between the second end portions of the pair of return flanges, and a bearing housing assembly selectively couplable to a portion of the beam.

In aspects, the beam may include at least one lip disposed on the second end portion of a corresponding return flange, the lip extending towards the web.

In certain aspects, the at least one lip may be truncated such that the at least one lip extends the length of one radius past the return flange.

In other aspects, the web may include a pair of linear sections disposed on opposing sides of the V-shaped notch.

In certain aspects, a length of each of the pair of linear sections may be equal.

In aspects, the V-shaped notch may define first and second portions extending towards the second end portions of the pair of legs and terminating at an apex.

In other aspects, a length of each of the pair of linear sections and a linear length of each of the first and second portions of the V-shaped notch extending between the pair of linear sections may be equal.

In aspects, the first and second potions of the V-shaped notch may define an angle of 165 degrees relative to the first and second portions.

In certain aspects, the bearing housing assembly may include a flange disposed thereon, the flange couplable to a portion of at least one leg of the pair of legs of the beam.

In other aspects, the bearing housing assembly may include a flange disposed thereon, the flange couplable to a portion of the web of the beam.

In according with another aspect of the present disclosure, a solar tracking system includes a beam including a pair of legs disposed in spaced relation to one another and extending between respective first and second end portions, a web extending between the first end portion of each of the pair of legs, the web including a V-shaped notch defined therein, and a pair of return flanges defining a respective first end portion disposed on respective second end portions of the pair of legs, the pair of return flanges extending from each respective leg of the pair of legs and terminating at a second end portion defining a gap between the second end portions of the pair of return flanges, and a drive assembly selectively couplable to a portion of the beam.

In aspects, the solar tracking system may include a torque tube operably coupled to a portion of the drive assembly such that actuation of the drive assembly effectuates rotation of the torque tube.

In certain aspects, the solar tracking system may include a bearing housing assembly operably coupled to a portion of the torque tube.

In other aspects, the solar tracking system may include a second beam, the second beam selectively couplable to a portion of the bearing housing assembly and configured to support the bearing housing assembly thereon.

In certain aspects, the beam may include at least one lip disposed on the second end portion of a corresponding return flange, the lip extending towards the web.

In aspects, the at least one lip may be truncated such that the at least one lip extends the length of one radius past the return flange.

In accordance with another aspect of the present disclosure, a pier for a solar tracking system includes a pair of legs disposed in spaced relation to one another and extending between respective first and second end portions, a web extending between the first end portion of each of the pair of legs, the web including a V-shaped notch defined therein, and a pair of return flanges defining a respective first end portion disposed on respective second end portions of the pair of legs, the pair of return flanges extending from each respective leg of the pair of legs and terminating at a second end portion defining a gap between the second end portions of the pair of return flanges, wherein at least one return flange of the pair of return flanges is configured to engage a portion of a bearing housing assembly.

In aspects, the web may include a pair of linear sections disposed on opposing sides of the V-shaped notch.

In certain aspects, the V-shaped notch may define first and second portions extending towards the second end portions of the pair of legs and terminating at an apex.

In other aspects, a length of each of the pair of linear sections and a linear length of each of the first and second portions of the V-shaped notch extending between the pair of linear sections may be equal.

### BRIEF DESCRIPTION OF THE DRAWINGS

Various aspects and features of the present disclosure are described hereinbelow with reference to the drawings, wherein:

FIG. 1 is a perspective view of a beam provided in accordance with the present disclosure;

FIG. 2 is a cross-sectional view of the beam of FIG. 1;

FIG. 2A is an enlarged view of the area of detail indicated in FIG. 2;

FIG. 3 is a perspective view of a solar tracking system utilizing the beam of FIG. 1;

FIG. 4 is a perspective view of a slew drive of the solar tracking system of FIG. 3;

FIG. 5 is a perspective, exploded view, of a mounting flange for the slew drive of FIG. 4;

FIG. 6 is a perspective view of another embodiment of a slew drive and mounting flange of the solar tracking system of FIG. 3;

FIG. 7 is a perspective view of a mounting flange of the slew drive of FIG. 6;

FIG. 8 is a perspective view of a bearing housing assembly of the solar tracking system of FIG. 3;

FIG. 9 is a perspective, exploded view, of the bearing housing assembly and beam of FIG. 8; and

FIG. 10 is a perspective view of another embodiment of a bearing housing assembly of the solar tracking system of FIG. 3.

### DETAILED DESCRIPTION

The present disclosure is directed to a pier or beam for use with a solar tracking system. The beam includes a generally C-shaped cross-sectional profile with various features to increase the overall stiffness of the beam in one or more directions while simultaneously reducing the amount of material required to obtain the desired stiffness as compared to a traditional C-channel of W-beam.

The beam includes a web interposed between two legs extending in a generally perpendicular direction from the web. The web includes a V-shaped notch defined therein and extending towards an interior portion of the beam. In this manner, the V-shaped notch defines four sections, two linear sections disposed adjacent each respective leg and two diagonal portions extending from each of the two linear sections and intersecting at a peak or apex. As can be appreciated, the V-shaped notch increases the overall stiffness of the beam and moves the centroid of the beam closer towards the geometric center of the beam.

Each of the legs include a return flange disposed at an end portion thereof and disposed at a generally perpendicular angle to each of the legs (e.g., parallel to the linear sections of the web). The return flanges extend towards one another and terminate a distance away from each other to define a gap therebetween.

Each return flange includes a lip disposed at an end portion thereof. The lips are disposed at a generally perpendicular angle to the return flanges (e.g., parallel to the legs) and extends towards the web. The lips are truncated or otherwise short compared to a length of the legs, and in embodiments, may extend the length of one radius past each respective return flange. As can be appreciated, the lips improve local stiffness of the beam and inhibit splaying or deformation of the beam as the beam is driven or otherwise embedded into the earth.

The beam is sized and dimensioned for use with a solar tracking system. In this manner, the beam includes one or more bores defined through a portion of the web or one or both of the legs such that a slew drive or bearing housing assembly may be selectively coupled to the beam. As can be appreciated, the slew drive and bearing housing assembly necessitate that the beam include certain maximum dimensions in order to be mounted or otherwise coupled thereto. The overall shape of the beam, including the V-shaped notch, return flanges, and lips, increases the overall stiffness of the beam over a conventional wide-flange beam (W-beam) and reduces the amount of material required to provide the requisite stiffness and load bearing capacity (e.g., reduces the thickness of the beam). These and other aspects of the present disclosure will be described in further detail herein.

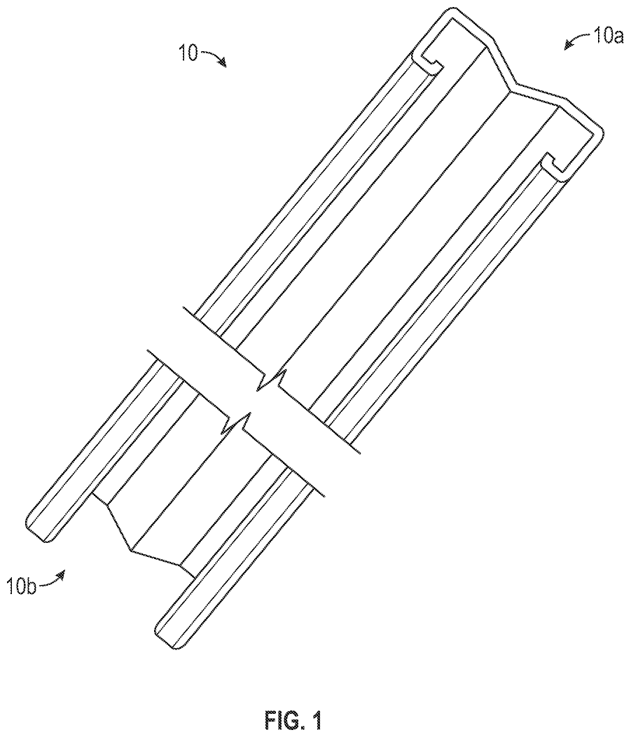

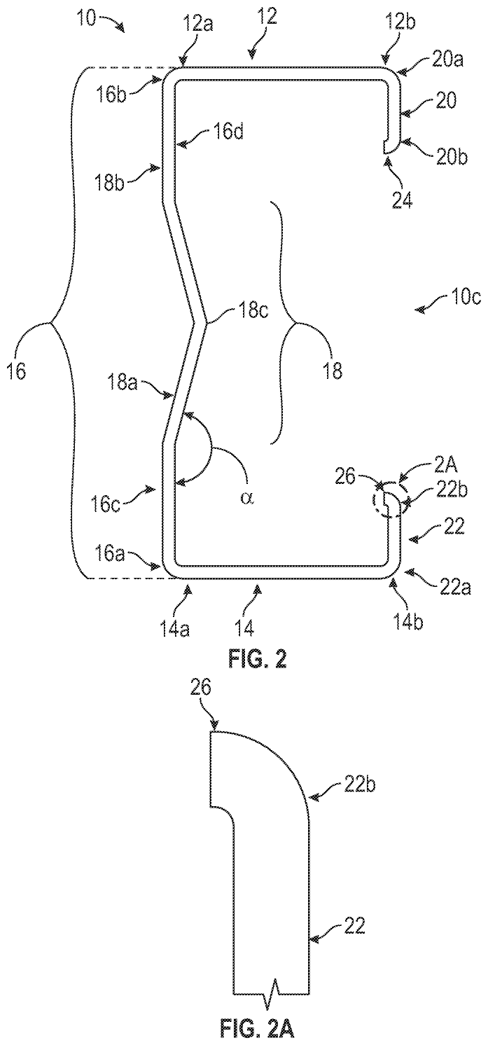

Referring now to the drawings, pier or beam provided in accordance with the present disclosure is illustrated in FIGS. 1, 2, and 2A and generally identified by reference numeral 10. As will be described in further detail hereinbelow, the beam 10 includes a generally C-shaped cross-section with various features configured to increase the stiffness of the beam 10 in one or more directions while simultaneously reducing the amount of material required to obtain the desired stiffness as compared to a traditional C-channel. The beam defines a generally C-shaped cross-sectional profile extending between opposed first and second end portions 10a and 10b, respectively. The C-shaped cross-sectional profile of the beam includes a pair of first and second flanges or legs 12, 14 disposed in spaced relation to one another and extending between opposed first and second end portions 12a, 12b and 14a, 14b, respectively. The beam includes a web or backspan 16 interposed between the first end portions 12a, 14a of the first and second legs 12, 14 and extending between opposed first and second end portions 16a, 16b. In this manner, the first end portion 16a of the web 16b is disposed adjacent to the first end portion 12a of the first leg 12 and the second end portion 16b is disposed adjacent to the first end portion 14a of the second leg 14.

The web 16 defines a generally linear profile extending between the first and second end portions 16a, 16b with a V-shaped notch 18 defined therein. In this manner, the web 16 defines four sections, a first linear section 16c, a first portion 18a of the V-shaped notch 18, a second portion 18b of the V-shaped notch 18, and a second linear section 16d. The V-shaped notch 18 is disposed generally at a center portion of the web 16 such that each of the four sections 16a, 18a, 18b, and 16b include generally equal lengths, although it is contemplated that any of the four sections 16a, 18a, 18b, and 16c may include any suitable length and the V-shaped notch 18 may be disposed at any suitable location along the web 16 depending upon the design needs of the beam 10. In embodiments, each of the four sections 16c, 18a, 18b, and 16d include the same or similar length, although it is contemplated that the length of each of the four sections 16c, 18a, 18b, 16d may be different than one another or include combinations of lengths (e.g., sections 16c and 16d have the same length and sections 18a and 18b have the same length but a length different to that of sections 16c, 16d, amongst others). In one non-limiting embodiment, each of the four sections 16c, 18a, 18b, 16d define a length of approximately 40 mm (linearly across the web 16) such that the web 16 defines an overall length of approximately 160 mm. As can be appreciated, the length of sections 18a, 18b of the V-shaped notch 18 is longer than 40 mm (e.g., the hypotenuse of sections 18a, 18b is longer than 40 mm) such that the linear space taken by each of the sections 18a, 18b is approximately 40 mm.

The first and second portions 18a, 18b of the V-shaped notch extend towards the second end portions 12b, 14b of the first and second legs 12, 14 and intersect at an apex or peak 18c. In embodiments, the first and second portions 18a, 18b define an angle α of approximately 165 degrees relative to the first and second linear sections 16c, 16d, although it is contemplated that the first and second portions 18a, 18b may define any suitable angle relative to the first and second linear sections 16c, 16d of the web 16 and each of the first and second portions 18a, 18b may define the same or different angle relative to the linear sections 16c, 16d of the web 16 depending upon the design needs of the beam 10.

Although generally illustrated as forming a generally sharp point at the apex 18c, it is envisioned that the shape of the apex 18c may be any suitable shape, such as rounded, planar, sharp, amongst others, depending upon the design needs of the beam 10. As can be appreciated, the V-shaped profile 18 breaks up the web 16 into multiple sections thereby increasing the overall stiffness of the beam 10 as compared to a typical C-channel and moves a centroid of the beam 10 closer to the geometric center of the beam 10, thereby increasing the buckling load capacity of the beam 10 as compared to a typical C-channel.

Continuing with FIGS. 2 and 2A, the first and second legs 12, 14 define a generally perpendicular angle with respect to the web 16 and the first and second legs 12, 14 are generally parallel to one another, although it is contemplated that the first and second legs 12, 14 may form any suitable angle relative to the web 16 and/or each other. Although generally illustrated as defining a linear profile, it is envisioned that the first and second legs 12, 14 may define any suitable profile, such as V-shaped, U-shaped, sinusoidal, etc. depending upon the design needs of the beam 10. It is envisioned that the first and second legs 12, 14 may include any suitable length depending upon the design needs of the beam 10 and may include the same or different length than one another. In one non-limiting embodiment, each of the first and second legs 12, 14 include a length of approximately 75 mm.

Each of the first and second legs 12, 14 includes a respective return flange 20 and 22 extending between respective first and second end portions 20a, 20b and 22a, 22b. The first end portions 20a, 22a of the return flanges 20, 22 are disposed adjacent the second end portions 12b, 14b of the first and second legs 12, 14, respectively. The return flanges 20, 22 define a generally perpendicular angle to each respective first and second leg 12, 14 such that the return flanges 20, 22 extend towards one another (e.g., return flange 20 extends towards the second leg 14 and return flange 22 extends towards the first leg 12), although it is contemplated that the return flanges 20, 22 may define any suitable angle relative to the first and second legs 12, 14 and may define the same or different angle relative to the first and second legs 12, 14 depending upon the design needs of the beam 10. The return flanges 20, 22 extend towards one another and terminate at a distance short of one another to define a gap 10c therebetween. It is envisioned that the return flanges 20, 22 may include any suitable length and may be the same or different than one another. In one non-limiting embodiment, each of the return flanges 20, 22 include a length of approximately 12 mm.

With continued reference to FIGS. 2 and 2A, each of the return flanges 20, 22 includes a respective lip 24 and 26 disposed adjacent to the respective second end portions 20b, 22b. Each of the lips 24, 26 defines a generally perpendicular angle relative to the return flanges 20, 22 and is generally parallel to the first and second legs 12, 14, although it is contemplated that the lips 24, 26 may define any suitable angle relative to the return flanges 20, 22, first and second legs 12, 14, and/or one another. Each of the lips 24, 26 extend from the return flanges 20, 22 and terminate at an end portion 24a, 26a, respectively. Although generally illustrated as being truncated or otherwise extending a short distance past the return flanges 20, 22, it is envisioned that the lips 24, 26 may define any suitable length and may be the same or different length to one another, depending upon the design needs of the beam 10. In one non-limiting embodiment, the lips 24, 26 extend past an inner portion of the return flanges 20, 22 the length of one radius of the bend forming the lips 24, 26 (e.g., the radius extends through 90 degrees). It is contemplated that the radius of the bend forming the lips 24, 26 may be any suitable radius, and in one non-limiting embodiment, the radius is 3 mm.

As can be appreciated, the lips 24, 26 improve local stiffness of the beam 10 over conventional C-channel or wide flange beams (W-Beam) with respect to the design needs of the beam 10 for use with a solar tracking system, as will be described in further detail hereinbelow. Further, the lips 24, 26 mitigate the potential for the first and second legs 12, 14 to splay or otherwise deflect outwards as the beam 10 is driven into the ground. As will be described in further detail hereinbelow, the length of the lips 24, 26 is such that it does not interfere with assembly of a bearing housing assembly (BHA) or other structure or device of a solar tracking system. In this manner, the overall shape and design of the beam 10 increases the overall stiffness and strength of an ordinary W-beam or the like while simultaneously reducing the amount of material used in the construction of the beam 10.

It is contemplated that the beam 10 may be formed from any suitable material, such as a metallic material (e.g., steel, aluminum, etc.), a non-metallic material (e.g., a polymer, composite, etc.), amongst others and combinations thereof. In one non-limiting embodiment, the beam 10 is formed from pre-galvanized steel, although it is envisioned that the beam 10 may be formed from steel having any suitable corrosion protection coating, such as Zinc, Aluminum, and Magnesium alloy coated steel (e.g., ZAM), Hot Dipped Galvanized (e.g., HDG), amongst others, and combinations thereof (e.g., extra coating or more resilient coating at high corrosion portions of the beam 10). It is envisioned that the beam 10 may be formed using any suitable method, such as stamping, extruding, bending, hydroforming, forging, casing, welding, amongst others and may be formed from a continuous sheet of material or from more than one piece of material joined together using any suitable means.

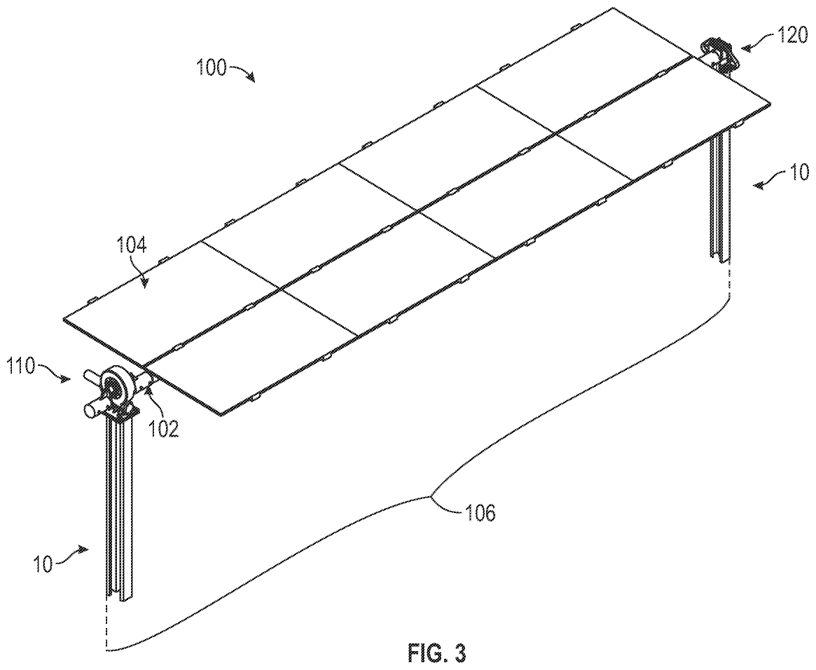

Turning to FIGS. 3-10, a solar tracking system utilizing the beam 10 is illustrated and generally identified by reference numeral 100. The solar tracking system 100 includes a plurality of piers or beams 10 disposed in spaced relation to one another and embedded in the earth. A torque tube 102 extends between each adjacent beam 10 and is rotatably supported on each beam 10. The solar tracking system 100 includes a plurality of solar panels 104 supported on the torque tube 102. The span between two adjacent beams 10 is referred to as a bay 106 and may be generally in the range of about 8 meters in length. A plurality of solar trackers may be arranged in a north-south longitudinal orientation to form a solar array.

The solar tracking system 100 includes at least one slew drive 110 operably coupled to the torque tube 102 and supported on a respective beam of the plurality of beams 10. The slew drive 110 effectuates rotation of the torque tube 102, which effectuates a corresponding rotation of the solar panels 104 to track the location of the sun. The solar tracker 100 includes at least one bearing housing assembly (BHA) 120 disposed on a respective beam of the plurality of beams 10. The bearing housing assembly 120 is operably coupled to the torque tube 102 to rotatably support the torque tube 102 therein as the torque tube 102 is caused to be rotated by the slew drive 110. Those having ordinary skill in the art will recognize that the slew drive assembly 110 and bearing housing assembly 112 are illustrative of any suitable drive or bearing housing assembly suitable for use with a solar tracking system, and therefore, the present disclosure should not be considered limited to the slew drive assembly 110 and/or bearing housing assembly 120 described herein.

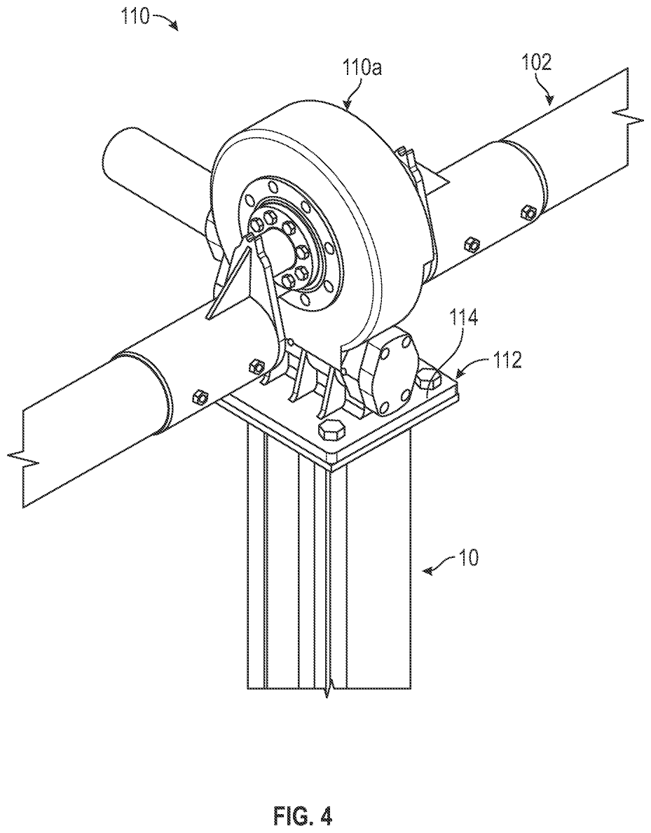

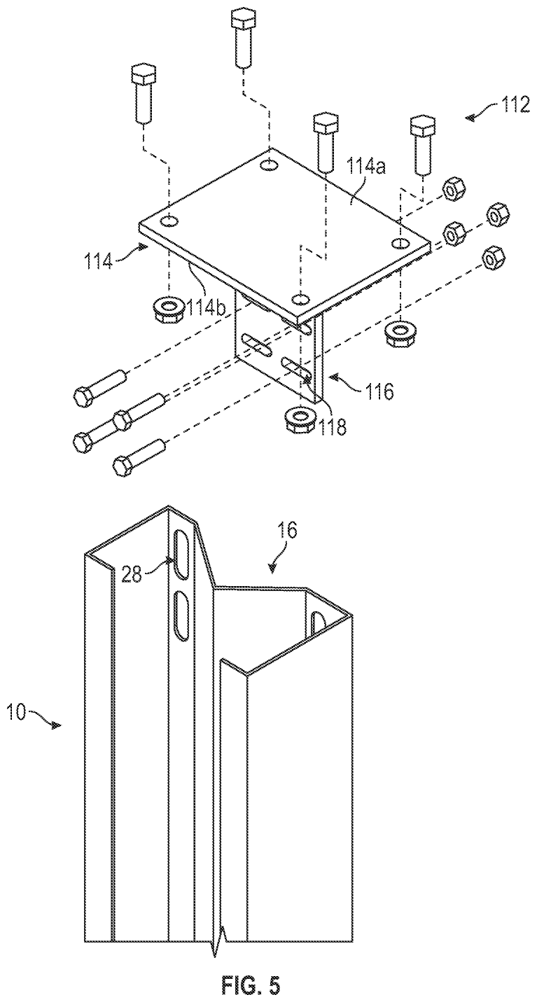

With reference to FIGS. 4 and 5, the slew drive assembly 110 includes a slew drive 110a and a mounting plate 112 that is selectively coupled thereto using any suitable means, such as fasteners, adhesives, welding, amongst others. The mounting plate 112 defines a generally T-shaped configuration having a top plate 114 and a flange 116 coupled to an underside of the top plate 114 a generally perpendicular angle. In this manner, the top plate 114 defines a generally rectangular configuration defining an upper surface 114a and an opposite, bottom surface 114b, although it is envisioned that the top plate 114 may define any suitable configuration, such as square, circular, oval, octagonal, amongst others. The upper side 114a is configured to abut or otherwise support the slew drive 110a. The flange 116 defines a generally rectangular profile that is coupled to the bottom surface 114b of the top plate 114 using any suitable means, such as fasteners, adhesives, welding, amongst others. The flange 116 include one or more through-bores 118 defined therethrough corresponding to one or more bores 28 defined through the web 16 of the beam 10 such that the mounting plate 112 can be selectively coupled thereto using one or more fasteners, although it is envisioned that the mounting plate 112 may be coupled to the beam 10 using any suitable means, such as adhesives, welding, rivets, amongst others. In one non-limiting embodiment, the flange 116 includes four through-bores 118 arranged in a pair of columns and a corresponding pair of rows (e.g., a 2×2 array). Although generally illustrated as having an oval profile, it is envisioned that the through-bores 118 of the flange 116 may include any suitable configuration, such as circular, or the like, and may extend in any suitable direction (e.g., vertically, horizontally, diagonal, etc.). Although generally described as being formed through a portion of the web 16 of the beam 10, it is envisioned that the bores 28 may be formed through one or both of the first and second legs 12, 14, a portion of the web 16 and one or both of the legs 12, 14, or combinations thereof.

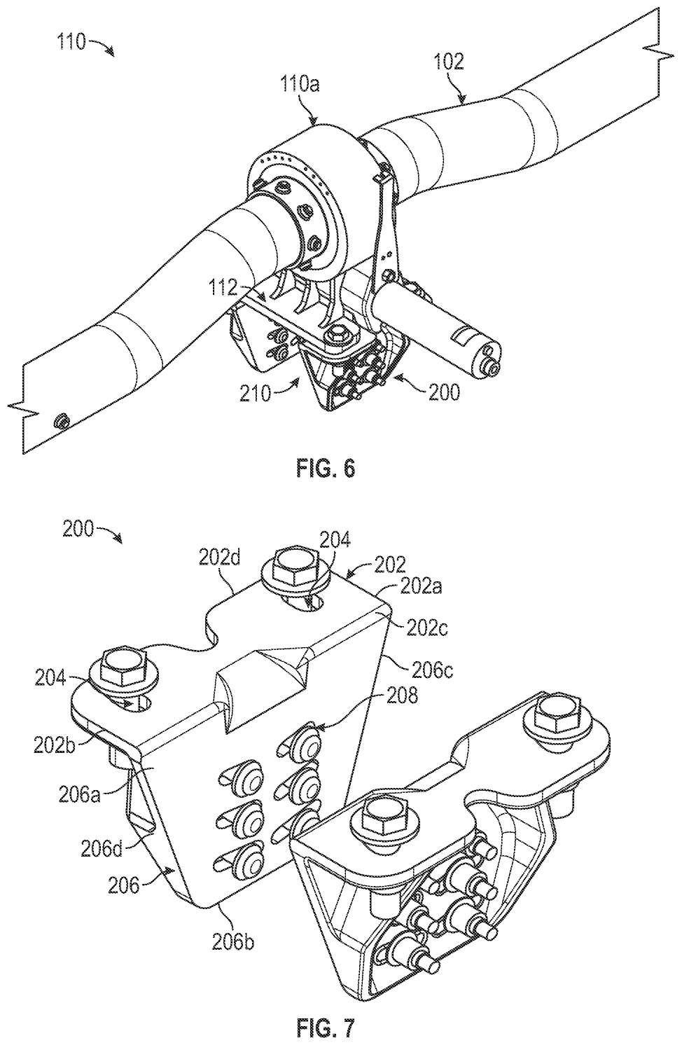

With reference to FIGS. 6 and 7, it is envisioned that the slew drive assembly 110 may utilize a pair of mounting brackets 200 in lieu of the mounting plate 112. Each mounting bracket of the pair of mounting brackets 200 is substantially similar to one another and therefore only one mounting bracket 200 will be described in detail herein in the interest of brevity.

The mounting bracket 200 defines a generally upside down “L” shaped profile having an upper flange 202 and a vertical flange 206 coupled thereto that forms a generally perpendicular angle relative to the upper flange 202. The upper flange 202 extends between opposed first and second end portions 202a and 202b respectively and opposed first and second side surfaces 202c and 202d, respectively and is configured to abut or otherwise support the slew drive 110a. The upper flange 202 includes a pair of bores 204 defined therethrough disposed adjacent each of the first and second end portions 202a and 202b. As can be appreciated, the pair of bores 204 of the upper flange 202 is configured to receive a corresponding fastener therethrough to selectively couple the slew drive 110a to the upper flange 202, although it is contemplated that the slew drive 110a may be coupled to the upper flange 202 using any suitable means, such as fasteners, welding, adhesives, amongst others.

The vertical flange 206 extends between opposed first and second end portions 206a and 206b, respectively and opposed first and second side surfaces 206c and 206d, respectively. The first end portion 206a of the vertical flange 206 is coupled to the second side surface 202d of the upper flange 202 using any suitable means, such as fasteners, welding, adhesives, amongst others, and the mounting bracket 200 may be formed from multiple components or as a unitary component, depending upon the design needs of the slew drive assembly 110. The vertical flange 206 includes one or more through-bores 208 defined therethrough corresponding to one or more bores 28 defined through one or both of the first and second legs 12, 14 of the beam 10 such that the vertical flange 206, and therefore, the mounting bracket 200, can be selectively coupled to the beam 10 using one or more fasteners, although it is contemplated that the vertical flange 206 may be coupled to the beam 10 using any suitable means, such as adhesives, welding, rivets, amongst others. In one non-limiting embodiment, the vertical flange 206 includes six through-bores 208 arranged in a pair of columns and three rows (e.g., a 2×3 array). Although generally illustrated as having an oval profile, it is envisioned that the through-bores 208 of the vertical flange 206 may include any suitable configuration, such as circular, or the like, and may extend in any suitable direction (e.g., vertically, horizontally, diagonal, etc.). In one non-limiting embodiment, each column of through-bores 208 includes through-bores 208 being disposed in a diagonal direction and in a mirrored fashion (e.g., angled downward toward a center portion of the vertical flange 206).

As can be appreciated, the pair of mounting brackets 200 is coupled to the slew drive 110a in a juxtaposed relationship such that a cavity 210 is formed therebetween that is configured to receive a portion of the beam 10 therein. In this manner, each mounting bracket of the pair of mounting brackets 200 is disposed adjacent a respective leg 12, 14, of the beam 10. It is envisioned that the pair of mounting brackets 200 may be formed from any suitable material, such as steel, aluminum, polymers, ceramics, composites, amongst others and may be formed using any suitable method, such as machining, additive manufacturing, forming (e.g., bending, hydroforming, extrusion, stamping, etc.), welding, amongst others.

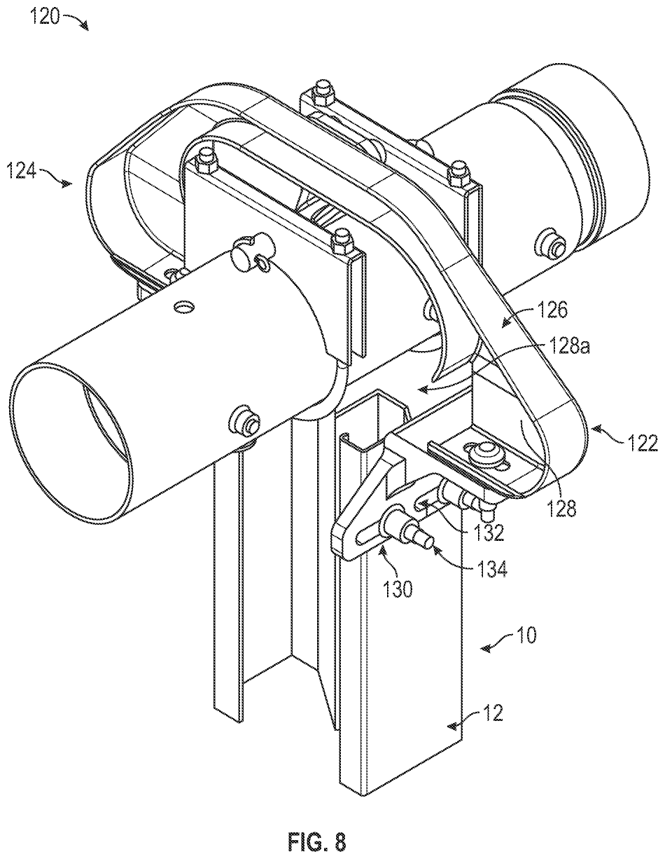

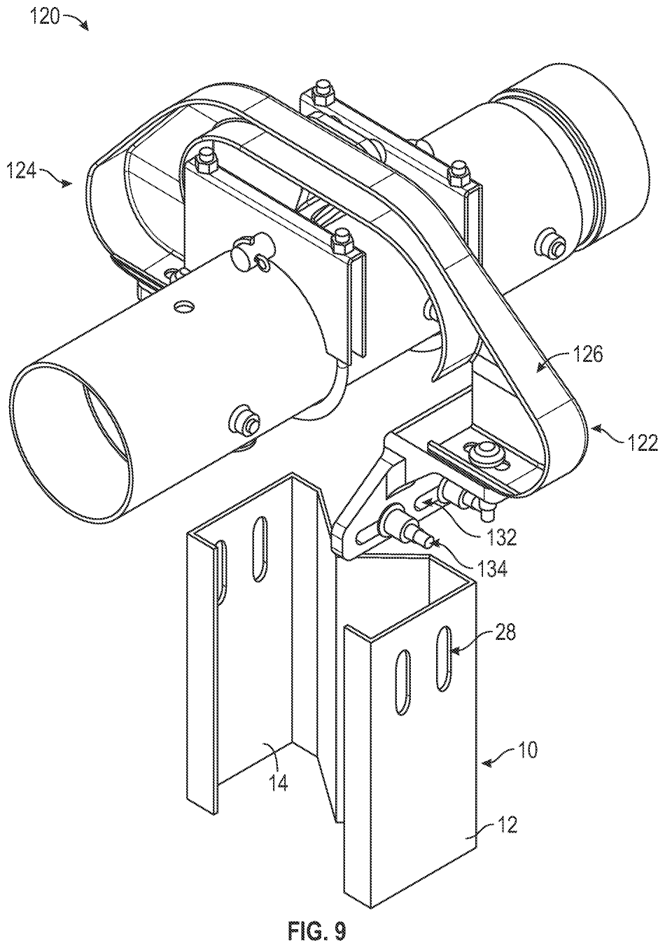

Turning to FIGS. 8 and 9, the bearing housing assembly 120 defines a generally oval shaped outer profile including opposed first and second side surfaces 122 and 124, respectively, and an outer surface 126 extending between each of the first and second side surfaces 122, 124. An inner surface 128 defines a cavity 128a extending through each of the first and second side surfaces 122, 124 and is configured to receive a portion of a torque tube 102 therethrough. A tab or flange 130 is disposed on a lower portion of the outer surface 126 and extends therefrom adjacent the first side surface 122. The flange 130 is disposed at a generally perpendicular angle relative to the first and second side surfaces 122, 124 such that the flange 130 is generally parallel with a leg of the first and second legs 12, 14 of the beam. Although generally described has having a single flange 130, it is envisioned that the bearing housing assembly 120 may include a pair of flanges 130 disposed in spaced relation to one another (e.g., disposed adjacent each respective first and second side surface 122, 124). It is envisioned that each flange 130 of the pair of flanges correspond to a respective leg of the first and second legs 12, 14. Although generally described with respect to the flange 130 of the bearing housing assembly 120, one having ordinary skill in the art would recognize that the same configuration may be employed with respect to the mounting plate 112 of the slew drive assembly 110.

The flange 130 is configured to be selectively coupled to a portion of the beam 10 using any suitable means, such as fasteners, welding, adhesives, amongst others. In one non-limiting embodiment, the flange 130 includes at least one through-hole 132 defined therethrough to accommodate a respective fastener 134 therein. In this manner, the at least one through-hole 132 of the bearing housing assembly 120 is configured to generally align with a corresponding at least one bore 28 defined through a portion of a leg 12 of the first and second legs 12, 14 of the beam 10 such that a respective fastener 136 may be received therethrough to selectively couple the bearing housing assembly 120 to the beam 10. In embodiments, the flange 130 of the bearing housing assembly 120 may include two through-holes 132 defined therethrough that generally align with two corresponding bores 28 defined through the first leg 12 of the beam 10. In this manner, the two through-holes 132 and the two bores 28 are disposed in a side-by-side configuration (e.g., one through-hole 132 is located adjacent the other through-hole 132 in a horizontal direction in a direction from the first end portion 12a towards the second end portion 12b of the first leg 12 of the beam). In embodiments, any or all of the through-holes 132 and/or bores 28 may be elongated (e.g., a slot) in a vertical or horizontal direction, or combinations thereof to permit adjustments of the bearing housing assembly 120 relative to the beam 10.

Although generally described as having bores defined through the first and/or second legs 12, 14 of the beam 10, it is envisioned that the beam 10 may include bores 28 defined through a portion of the web 16. In this manner, the flange 130 of the bearing housing assembly 120 may be disposed in a horizontal configuration (e.g., extending between the first and second side surface 122, 124). It is envisioned that the bearing housing assembly may include one or both of the flanges disposed adjacent the first and second side surfaces 122, 124 in addition to the flange 130 disposed between the first and second side surfaces 122, 124 may include only the flange disposed between the first and second side surfaces 122, 124, or any combination thereof.

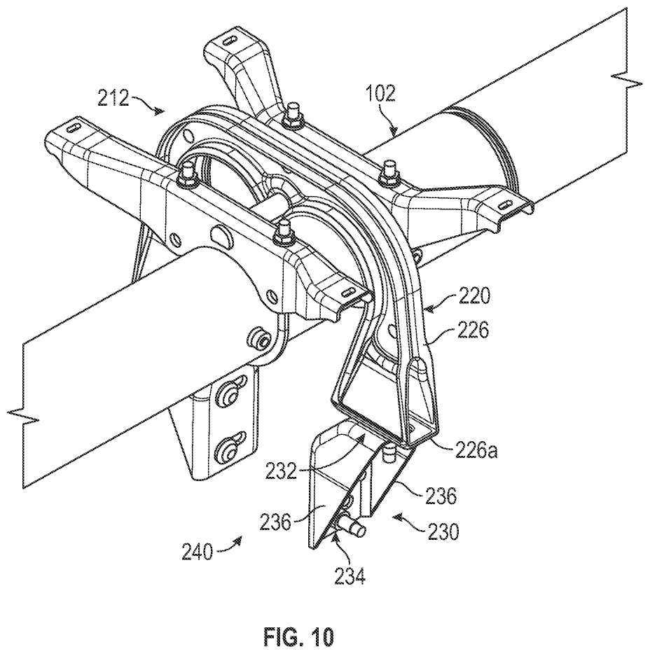

With reference to FIG. 10, another embodiment of a bearing housing assembly is illustrated and generally identified by reference numeral 212. The bearing housing assembly 212 is substantially similar to the bearing housing 120 described herein above and therefore, only the differences therebetween will be described in detail herein in the interest of brevity.

The bearing housing assembly 212 includes a bearing housing 220 and a pair of mounting flanges 230 selectively coupled thereto. The bearing housing 220 is substantially similar to the bearing housing assembly 120 except that the bearing housing 220 does not include the flange 130, and rather, includes a generally planar mounting surface 226a formed on a lower portion of the outer surface 226. The mounting surface 226a of the bearing housing is configured to abut or otherwise engage a corresponding portion of a respective mounting flange of the pair of mounting flanges 230. In this manner, the bearing housing 220 includes a pair of mounting surfaces 226a disposed in spaced relation to one another (e.g., disposed adjacent each respective first and second side surface 222, 224). It is envisioned that the mounting surface 226a may include a hole (not shown) defined through a portion thereof that is configured to receive a fastener (not shown) therein to selectively couple the bearing housing 220 to each respective mounting flange of the pair of mounting flanges 230. As can be appreciated, the hole may include any suitable profile, such as circular, oval, etc. and may be disposed in any suitable orientation.

Each mounting flange of the pair of mounting flanges 230 is substantially similar and therefore, only one mounting flange 230 will be described herein in the interest of brevity. The mounting flange 230 defines a generally lowercase “r” shaped profile having an upper flange 232 and a vertical flange 234 coupled thereto. The upper flange 232 and the vertical flange 234 are joined together at a generally perpendicular angle, although it is envisioned that the upper flange 232 and the vertical flange 234 may be joined together at any suitable angle. The upper flange 232 is configured to abut or otherwise support the bearing housing 220 via the mounting surface 226a. The vertical flange 234 is configured to abut a leg 12 or 14 of the beam 10. It is envisioned that the bearing housing 220 and the beam 10 may be coupled to the mounting flange 230 using any suitable means, such as fasteners, adhesives, welding, amongst others. In one non-limiting embodiment, the vertical flange 234 may include one or more through-bores (not shown) defined therethrough that are configured to receive a respective fastener therethrough to couple the mounting flange 230 to the beam 10. The pair of mounting flanges 230 is disposed in spaced relation to one another to form a cavity 240 therebetween that is configured to receive a portion of the beam 10 therein. In this manner, each mounting flange of the pair of mounting flanges 230 is disposed adjacent a respective leg 12, 14, of the beam 10.

In embodiments, the mounting flange 230 may include at least one gusset 236 extending between the upper flange 232 and the vertical flange 234 forming a cavity 238 within an interior portion thereof to provide additional stiffness and/or resistance to bending. It is envisioned that the mounting bracket 230 may be formed from any suitable material, such as steel, aluminum, a polymer, a composite, a ceramic, etc. and may be formed using any suitable method, machining, additive manufacturing, forming (e.g., bending, hydroforming, extrusion, stamping, etc.), welding, amongst others.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments.

What is claimed is:

1. A solar tracking system, comprising:
a beam, including:
a pair of legs disposed in spaced relation to one another and extending between respective first and second end portions;
a web extending between the first end portion of each of the pair of legs, the web including a V-shaped notch defined therein; and
a pair of return flanges defining a respective first end portion disposed on respective second end portions of the pair of legs, the pair of return flanges extending from each respective leg of the pair of legs and terminating at a second end portion defining a gap between the second end portions of the pair of return flanges; and
a bearing housing assembly selectively couplable to a portion of the beam.

2. The solar tracking system according to claim 1, wherein the beam further comprises at least one lip disposed on the second end portion of a corresponding return flange, the lip extending towards the web.

3. The solar tracking system according to claim 2, wherein the at least one lip is truncated such that the at least one lip extends the length of one radius past the return flange.

4. The solar tracking system according to claim 1, wherein the web includes a pair of linear sections disposed on opposing sides of the V-shaped notch.

5. The solar tracking system according to claim 4, wherein a length of each of the pair of linear sections is equal.

6. The solar tracking system according to claim 4, wherein the V-shaped notch defines first and second portions extending towards the second end portions of the pair of legs and terminating at an apex.

7. The solar tracking system according to claim 6, wherein a length of each of the pair of linear sections and a linear length of each of the first and second portions of the V-shaped notch extending between the pair of linear sections is equal.

8. The solar tracking system according to claim 6, wherein the first and second portions of the V-shaped notch define an angle of 165 degrees relative to the first and second portions.

9. The solar tracking system according to claim 1, wherein the bearing housing assembly includes a flange disposed thereon, the flange couplable to a portion of at least one leg of the pair of legs of the beam.

10. The solar tracking system according to claim 1, wherein the bearing housing assembly includes a flange disposed thereon, the flange couplable to a portion of a portion of the web of the beam.

11. A solar tracking system, comprising:
a beam, comprising:
a pair of legs disposed in spaced relation to one another and extending between respective first and second end portions;
a web extending between the first end portion of each of the pair of legs, the web including a V-shaped notch defined therein; and
a pair of return flanges defining a respective first end portion disposed on respective second end portions of the pair of legs, the pair of return flanges extending from each respective leg of the pair of legs and terminating at a second end portion defining a gap between the second end portions of the pair of return flanges; and
a drive assembly selectively couplable to a portion of the beam.

12. The solar tracking system according to claim 11, further including a torque tube, the torque tube operably coupled to a portion of the drive assembly such that actuation of the drive assembly effectuates rotation of the torque tube.

13. The solar tracking system according to claim 12, further including a bearing housing assembly operably coupled to a portion of the torque tube.

14. The solar tracking system according to claim 13, further including a second beam, the second beam selectively couplable to a portion of the bearing housing assembly and configured to support the bearing housing assembly thereon.

15. The solar tracking system according to claim 11, wherein the beam further comprises at least one lip disposed on the second end portion of a corresponding return flange, the lip extending towards the web.

16. The solar tracking system according to claim 15, wherein the at least one lip is truncated such that the at least one lip extends the length of one radius past the return flange.

17. A pier for a solar tracking system, comprising:
a beam, including:
a pair of legs disposed in spaced relation to one another and extending between respective first and second end portions;
a web extending between the first end portion of each of the pair of legs, the web including a V-shaped notch defined therein; and
a pair of return flanges defining a respective first end portion disposed on respective second end portions of the pair of legs, the pair of return flanges extending from each respective leg of the pair of legs and terminating at a second end portion defining a gap between the second end portions of the pair of return flanges,
wherein at least one return flange of the pair of return flanges is configured to engage a portion of a bearing housing assembly.

18. The solar tracking system according to claim 17, wherein the web includes a pair of linear sections disposed on opposing sides of the V-shaped notch.

19. The solar tracking system according to claim 17, wherein the V-shaped notch defines first and second portions extending towards the second end portions of the pair of legs and terminating at an apex.

20. The solar tracking system according to claim 19, wherein a length of each of the pair of linear sections and a linear length of each of the first and second portions of the V-shaped notch extending between the pair of linear sections is equal.
